(19) United States
(12) Patent Application Publication
(10) Pub. No.: US 2013/0117393 A1
(43) Pub. Date: May 9, 2013

(54) EMAIL MESSAGE HANDLING BASED ON DATA OF NON-EMAIL INTERACTIONS

(71) Applicant: ACTIVEPATH LTD., Petah-Tiqva (IL)

(72) Inventor: Ram COHEN, Tel Aviv (IL)

(73) Assignee: ACTIVEPATH LTD., Petah-Tiqva (IL)

(21) Appl. No.: 13/671,128

(22) Filed: Nov. 7, 2012

Related U.S. Application Data
(60) Provisional application No. 61/556,300, filed on Nov. 7, 2011.

(51) Int. Cl. G06F 15/16

(52) U.S. Cl. 709/206

(57) ABSTRACT

Systems, methods, and/or computer program products for handling email messages. In some embodiments, data relating to non-email interactions involving a user and one or more parties may be stored in memory. Therefore, in these embodiments it may be determined, at least partly based on this data, how to handle an email message for the user from an email address associated with any of these party/ies.

### CROSS REFERENCE TO RELATED APPLICATIONS

This application claims the benefit of U.S. provisional No. 61/556,300 filed Nov. 7, 2011, which is hereby incorporated by reference herein.

### TECHNICAL FIELD

The disclosure relates to handling of electronic mail (“email”) messages.

### BACKGROUND

Messages are widely used for communicating information between senders and recipients. However there are many attempts to send either malicious or unsolicited material (known as SPAM) using messaging.

To solve the problem of spam and malicious content many providers such as Internet service providers (ISPs) or webmail providers (e.g. Gmail, Hotmail, Yahoo!, etc.) perform content scanning of the messages to determine the risk of the contents and assess the probability that a message is spam.

The common format of sending message textual content is using hypertext markup language HTML. Messages written in HTML may be nicely formatted and will adjust themselves to the limitations of the recipient's system, may include graphic elements, complex fonts, interactive features, scripts and embedded object elements (such as Adobe Flash and Microsoft Silverlight). Such elements may act as an application within the message, enriching the recipient's experience and providing enhanced functionality, making content more pleasant to read, providing product differentiation and branding to newsletters, and/or enabling interaction of the recipient with the content.

A common denominator to most webmail providers is the filtering of potentially harmful elements from message content, such as filtering scripts and objects from HTML content.

Another common practice is to not automatically show images referenced in the HTML content since mass mailers sending SPAM may use the images as a beacon that can notify them if a particular recipient has indeed received and opened a specific message.

Instead, most webmail providers initially show the message content without the images and offer the recipient the option of viewing the images by clicking a “download images” button. Usually, this is done only for “unknown” senders, i.e. senders that are not in the recipient's address list or with whom the recipient did not communicate in the past. It is also possible for the webmail provider to have a “white list” of senders for which it does not filter images as they are considered to be senders of legitimate content.

However showing to the recipient an HTML message without the images results in a poor user experience. The displayed message is ugly and often unreadable, and the recipient has to manually select the “download images” option and wait for the message to be retrieved again from the server (this time including the images) before he can read it.

This scenario of receiving a filtered version of the message, opting to receive the non-filtered version and receiving the non-filtered version may be repeated for other message elements as well. It is also possible to have such a scenario for allowing HTML forms, HTML objects, scripts, message attachments or any other message element that can be filtered.

Another element in a message, for example, can be markers (tags) that trigger fetching of additional message data as described in some embodiments of U.S. application Ser. No. 13/193,120. Activating the operation(s) for fetching the additional message data may possibly be subject to recipient authorization. Consequently, in cases where the fetching is subject to recipient authorization, a recipient who receives a message from a malicious sender or a sender who has been hacked may be protected from automatic activation.

Generally speaking, the process in which the recipient views a filtered version (and/or incomplete version) of content, opts to view a non or less filtered version, and/or more complete version of the content, waits for the additional content to be downloaded and presented, is not convenient and results in a poor user experience.

### SUMMARY

In one aspect, in accordance with the presently disclosed subject matter there is provided a method of enabling determination of handling of email messages, comprising: storing in memory data relating to non-email interactions, via a network, involving a user and one or more parties; thereby enabling determination of handling of email messages for the user, at least partly based on the data.

In some embodiments of the method, the data includes data relating to manners of interaction, and wherein the thereby enabling includes: thereby enabling determination of handling at least partly based on the manners of interaction. In some of these embodiments, the manners of interactions include channels of interaction. In some of these embodiments, the manners of interaction include operations performed during interactions.

In some embodiments of the method, the data includes at least one selected from a group comprising: dates or times of day of interaction, and wherein the thereby enabling includes: thereby enabling determination of handling at least partly based on the dates or times of day of interaction.

In some embodiments of the method, the data includes at least one selected from a group comprising identifiers of parties, associated email addresses or associated sending domains, and wherein the thereby enabling includes: thereby enabling determination of handling at least partly based on whether or not parties are members of a group of predetermined members.

In some embodiments, the method further comprises: associating parties with email addresses or sending domains, wherein the data includes at least one selected from a group comprising: the email addresses or the sending domains.

In some embodiments of the method, the data includes identifiers of the parties.

In some embodiments of the method, the non-email interactions include at least one selected from a group comprising: visiting a website, activating a mobile application, downloading a mobile application, other interacting with a mobile application, activating a non-mobile application, downloading a non-mobile application, other interacting with a non-mobile application, interacting with a social network account, interacting with a social network page, other interacting via a social network, or receiving a non-email message.

In some embodiments of the method, the thereby enabling includes: thereby enabling determination to apply predetermined handling to an email message from an email address associated with any of the parties.

In some embodiments, the method further comprises: determining not to store in memory data relating to at least one non-email interaction involving the user, based on at least one selected from a group comprising: date of interaction, time of day of interaction, party identifier, manner of interaction, or data relating to at least one previous non-email interaction already in memory.

In another aspect, in accordance with the presently disclosed subject matter there is provided a method of handling email messages, comprising: determining, at least partly based on available data relating to at least one non-email interaction involving a user and at least one party, how to handle an email message for the user sent via a network from an email address associated with the at least one party; and handling the email message in accordance with the determining.

In some embodiments of the method, the determining includes: determining to apply predetermined handling to the email message because the available data relates to at least one non-email interaction involving the user and the at least one party.

In some embodiments of the method, the determining includes: determining how to handle the email message at least partly based on whether or not any of the at least one party is a member of a predetermined group of members.

In some embodiments of the method, the data includes manner of interaction and wherein the determining includes: determining how to handle the email message at least partly based on the manner.

In some embodiments of the method, the data includes at least one of date or time of day of interaction and wherein the determining includes: determining how to handle the email message at least partly based on the date or time of day.

In some embodiments of the method, the handling includes: authorizing at least one element in the email message.

In some embodiments of the method, the handling includes: adding at least one element to the email message.

In some embodiments of the method, the handling includes at least one selected from a group comprising: classifying the email message differently than if predetermined handling was not applied, placing the email message in a predetermined folder; enabling email message to be displayed differently than if predetermined handling was not applied.

In some embodiments, the method further comprises: associating the email address with the at least one party.

In some embodiments, the method further comprises: determining that the email address includes a sending domain which matches a sending domain associated with the at least one party, or that the email address matches an email address associated with the at least one party.

In another aspect, in accordance with the presently disclosed subject matter there is provided a system for enabling determination of handling of email messages, comprising: a tracker capable of storing in memory data relating to non-email interactions via a network involving a user and one or more parties; thereby enabling determination of handling of email messages for the user, at least partly based on the data.

In some embodiments, the system is comprised in at least one selected from a group including: a user system of the user or the network.

In another aspect, in accordance with the presently disclosed subject matter there is provided a system for handling email messages, comprising: a checker capable of determining, at least partly based on available data relating to at least one non-email interaction involving a user and at least one party, how to handle an email message for the user sent via a network from an email address associated with the at least one party; and a handler capable of handing the email message in accordance with the determining.

In some embodiments, the system is comprised in at least one selected from a group including: a user system of the user, the network, or a system associated with a mailbox provider.

In some embodiments, the system further comprises: memory including at least part of the available data. In some of these embodiments, at least part of the memory is located in a same location as the checker, or at least part of the memory is located in a remote location from the checker.

In another aspect, in accordance with the presently disclosed subject matter there is provided a computer program product comprising a non-transitory computer useable medium having computer readable program code embodied therein for enabling determination of handling of email messages, the computer program product comprising: computer readable program code for causing the computer to store in memory data relating to non-email interactions, via a network, involving a user and one or more parties; thereby enabling determination of handling of email messages for the user, at least partly based on the data.

In another aspect, in accordance with the presently disclosed subject matter there is provided a computer program product comprising a non-transitory computer useable medium having computer readable program code embodied therein for handling email messages, the computer program product comprising: computer readable program code for causing the computer to determine, at least partly based on available data relating to at least one non-email interaction involving a user and at least one party, how to handle an email message for the user sent via a network from an email address associated with the at least one party; and computer readable program code for causing the computer to handle the email message in accordance with the determining.

### BRIEF DESCRIPTION OF THE DRAWINGS

In order to understand the subject matter and to see how it may be carried out in practice, embodiments will now be described, by way of non-limiting example only, with reference to the accompanying drawings, in which:

FIG. 1a illustrates an email interaction involving a user, according to some embodiments of the presently disclosed subject matter;

FIG. 1b illustrates a non-email interaction involving a user, according to some embodiments of the presently disclosed subject matter;

FIG. 2 illustrates a data structure, relating to interactions, which is stored in a memory, according to some embodiments of the presently disclosed subject matter;

FIG. 3 is a block diagram of a system for enabling determination of handling of email messages, according to some embodiments of the presently disclosed subject matter;

FIG. 4 is a block diagram of a system for handling email messages, according to some embodiments of the presently disclosed subject matter;

FIG. 5 is a flowchart of a method of enabling determination of handling of email messages, according to some embodiments of the presently disclosed subject matter; and

FIG. 6 is a flowchart of a method of handling email messages, according to some embodiments of the presently disclosed subject matter.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

Disclosed are some embodiments of systems, methods, and computer program products for handling email messages. In some of these embodiments, data relating to non-email interactions involving a user and one or more parties may be stored in memory, and therefore, it may be determined, at least partly based on this data, how to handle an email message for the user from an email address associated with any of these party/ies.

In the following detailed description, numerous specific details are set forth in order to provide a thorough understanding of the subject matter. However, it will be understood by those skilled in the art that some embodiments of the subject matter may be practiced without these specific details. In other instances, well-known stages, methods, modules, elements, and systems have not been described in detail so as not to obscure the subject matter.

As used herein, and unless explicitly stated otherwise, the term “memory” refers to any module for storing data for the short and/or long term, locally and/or remotely. Examples of memory include inter-alia: any type of disk including floppy disk, hard disk, optical disk, CD-ROMs, magnetic-optical disk, magnetic tape, flash memory, random access memory (RAMs), dynamic random access memory (DRAM), static random access memory (SRAM), read-only memory (ROMs), programmable read only memory PROM, electrically programmable read-only memory (EPROMs), electrically erasable and programmable read only memory (EEPROMs), magnetic card, optical card, any other type of media suitable for storing electronic instructions and capable of being coupled to a system bus, a combination of any of the above, etc.

Usage in the specification of the term “such as”, “e.g.”, “possibly”, “it is possible”, “optionally”, “say”, “one embodiment”, “embodiments”, “an embodiment”, “some embodiments”, “various embodiments”, “other embodiments”, illustrated embodiments”, “another embodiment”, “for example” “one example”, “an example” “some examples”, “examples”, ““another example”, “various examples”, “other examples”, “for instance”, “an instance”, “one instance”, “some instances”, “another instance”, “other instances”, “various instances” “one case”, “cases”, “some cases”, “another case”, “other eases”, “various cases”, or variants thereof means that a particular described feature, structure or characteristic is included in at least one non-limiting embodiment of the subject matter, but not necessarily included in all embodiments. The appearance of the same term does not necessarily refer to the same embodiment(s).

The term “illustrated embodiments”, is used to direct the attention of the reader to one or more of the figures, but should not be construed as necessarily favoring any embodiment over any other.

It should be appreciated that certain features disclosed herein, which are, for clarity, described in the context of separate embodiments, may also be provided in combination in a single embodiment. Conversely, various features, structures and/or characteristics disclosed herein, which are, for brevity, described in the context of a single embodiment, may also be provided separately or in any suitable sub-combination.

Unless specifically stated otherwise, as apparent from the following discussions, it is appreciated that throughout the specification discussions utilizing terms such as “tracking”, “enabling”, “handling”, “associating”, visiting”, “browsing”, “viewing” “activating”, “downloading”, “interacting”, “following”, “determining”, “applying”, “authorizing”, “filtering”, “classifying”, “placing”, “displaying”, “storing”, “recording”, “checking”, “sending”, “receiving”, ““performing”, “indicating”, “providing”, “matching”, “causing”, “detecting”, “retrieving”, “executing”, “allowing”, “using”, or the like, refer to the action and/or processes of any combination of software, hardware and/or firmware. For example, these terms may possibly refer in some cases to the action(s) and/or process(es) of one or more computer(s), specially constructed for the desired purposes, and/or one or more computer(s) selectively activated or reconfigured by specially constructed program code, that manipulate(s) and/or transform(s) data represented as physical, such as electronic quantities, within the registers and/or memories of the computer(s) into other data similarly represented as physical quantities within the memories, registers and/or other such information storage, transmission and/or display element(s) of the computer(s). The term “computer” should be expansively construed to cover any kind of electronic system which includes at least some hardware and has data processing capabilities, even if not labeled as such.

Any trademark occurring in the text or drawings is the property of its owner and occurs herein merely to explain or illustrate one example of how an embodiment of the invention may be implemented.

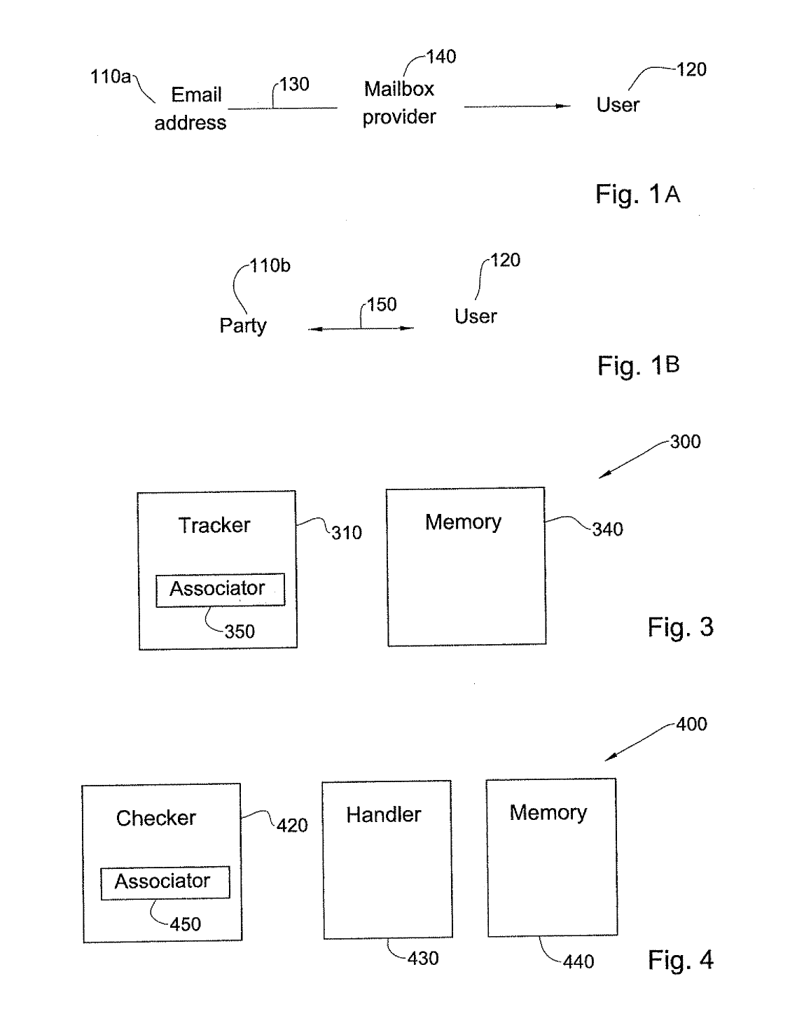

Referring now to the drawings, FIG. 1a illustrates an email interaction involving a user 120, according to some embodiments of the presently disclosed subject matter. In the illustrated embodiments, user 120 may be the designated recipient of an email message (sent) from an email address 110a (i.e. the email message is for user 120). Mailbox provider 140 accepts and stores messages sent to user 120 and provides access to the messages for user 120. Examples of mailbox provider 140 may include a webmail provider, an Internet service provider, a mail transfer agent/mail delivery agent, etc. The channel in a network via which the email travels from sending user 110 to user 120 via mailbox provider 140 is referred to herein as email channel 130.

FIG. 1b illustrates a non-email interaction involving user 120, according to some embodiments of the presently disclosed subject matter. User 120 may interact with a party 110b associated with email address 110a via a non-email channel 150 in a network. Non email channel 150 may be any non-email channel, which allows non-email interaction involving party 110b and user 120 as will be described in more detail below.

The disclosure does not limit the type of party 110b, but for the sake of further illustration to the reader some examples are now presented. Party 110b may be for example, an individual, a group of individuals, an organization, a company, an object affiliated with any of the above (e.g. website, application, account, page, etc), etc.

Depending on the embodiment, email address 110a may be associated with one or more parties (including party 110b). Additionally or alternatively, depending on the embodiment, party 110b may be associated with one or more email addresses (including email address 110a).

Features of email channel 130 and features of non-email channel 150 may vary depending on the embodiment. Email channel 130 may comprise any suitable infrastructure which allows an email from email address 110a to reach user 120. It is noted that emails from the same email address to the same user do not necessarily always pass in the same path, but for simplicity's sake, the description refers to email channel 130 in the singular form. Non-email channel 150 may comprise any suitable infrastructure which allows non-email interaction involving party 110b and user 120. It is noted that non-email interaction involving user 120 and party 110b does not necessarily always use the same path, but for simplicity's sake, the description refers to non-email channel 150 in the singular form. Possibly a network may include additional email and/or non-email channels for interactions involving user 120, for instance involving different email address(es) than email address 110a and/or different party/ies than party 110b. In any of the channels (130, 150, or other) any technology (e.g. wired and/or wireless) may be implemented, for example including technology implemented in any network such as a cellular network, personal area network, local area network, wide area network, internetwork, Internet, a network comprising any combination of the above networks, etc.

Depending on the embodiment, user 120 may be associated with one or more user systems. Examples of user system(s) may include personal computer(s), cell phone(s), smartphone(s), laptop(s), tablet computer(s), any other user device(s), etc.

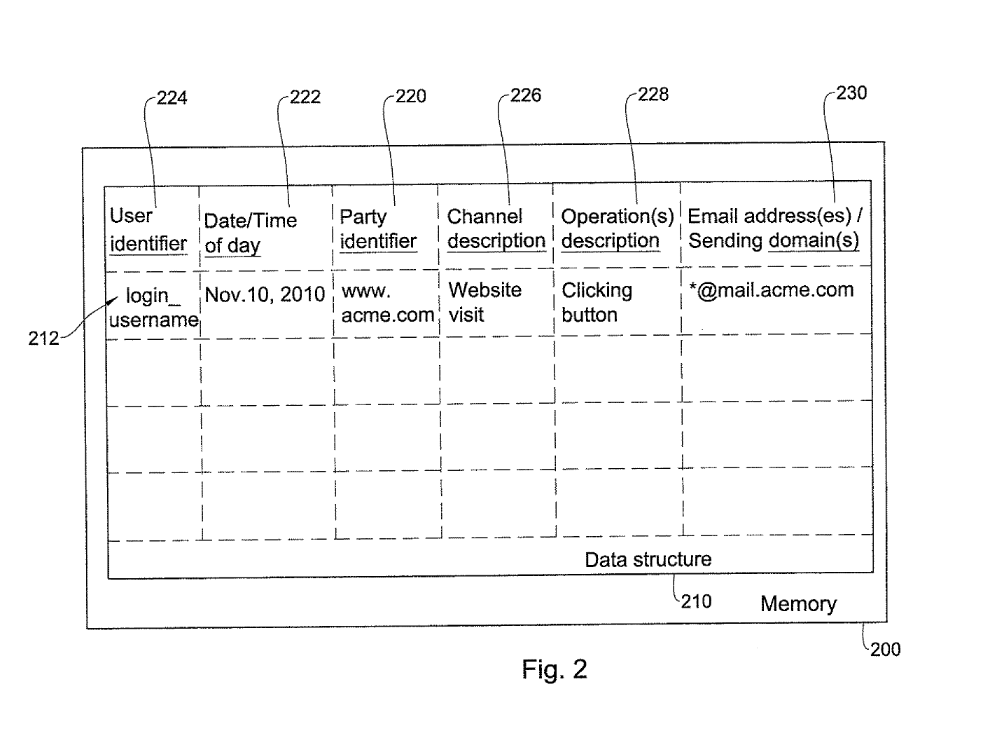

FIG. 2 illustrates a data structure 210, relating to interactions, which is stored in a memory 200, according to some embodiments of the presently disclosed subject matter.

In the illustrated embodiments, it is assumed that user 120 visited (also referred to herein as browsed) a website 110b (i.e. in these embodiments party 110b is a website). Data on this interaction may be noted, for example in an entry corresponding to row 212. For instance assuming a column 220 of data structure 210 includes identifiers of parties with which user 120 had non-email interactions, the name of the website may be noted for this interaction (in the illustrated embodiments “www.acme.com”) in a field corresponding to row 212 and column 220. Additionally or alternatively, for instance, assuming a column 222 includes interaction dates and/or times, the date and/or time of day of the interaction may be noted in a field corresponding to row 212 and column 222 (in the illustrated embodiments “Nov. 10, 2010”). Additionally or alternatively for instance, assuming a column 224 includes identifiers of users for which interactions are being recorded, an identifier of user 120 may be noted in a field corresponding to row 212 and a column 224 (in the illustrated embodiments, “login username”). Additionally or alternatively for instance, the manner of the non-email interaction may be noted in data structure 210. A description of the manner of the non-email interaction may include any suitable data. For example, a description of the manner may include a description of the channel of interaction and/or a description of operation(s) performed by user 120 during the interaction. Continuing with this example, assuming a column 226 includes channel descriptions and a column 228 includes operation descriptions, a description of the channel of interaction may be noted in a field corresponding to row 212 and column 226 (in the illustrated embodiment embodiments “website visit”), and a description of one or more operations may be noted in a field corresponding to row 212 and a column 228 (in the illustrated embodiments “clicking button”). Additionally or alternatively for instance, assuming a column 230 includes email addresses and/or sending domains associated with parties to interactions, email address(es) (e.g. 110a) and/or sending domain(s) associated with party 110b may be noted in a field corresponding to row 212 and column 230 (in the illustrated embodiments, “*@mail.acme.com”, where “*” is a wildcard). Additionally, or alternatively, for instance other data relating to the interaction may be noted in the entry corresponding to row 212, such as other associated party/ies related to party 110b (e.g. Twitter account, Facebook page, Linkedin page, etc).

The disclosure does not limit the form and/or content of data structure 210 and therefore data structure 210 may include any appropriate form and content, not necessarily similar to what is illustrated in FIG. 2. For instance, depending on the embodiment, data structure 210 may or may not have data arranged in columns and rows. Additionally or alternatively, for instance, depending on the embodiment, data structure 210 may include data on non-email interactions involving user 120, or data on both email and non-email interactions involving user 120. Additionally or alternatively, for instance, depending on the embodiment, data structure 210 may include data on all non-email interactions or not necessarily on all non-email interactions involving user 120, e.g. dependent on party with which user 120 had an interaction, dependent on date and/or time of day of interactions, and/or dependent on manner of interaction, etc. In some cases where data on an interaction may or may not be included at least partly dependent on identifier of the party to the interaction, there may be a group of predetermined members and interactions with parties which are members of this group may be included (or excluded) in data structure 210 whereas parties which are not members may be excluded (or included) in data structure 210. In some cases where data on an interaction may or may not be included at least partly dependent on manner of interaction, interactions of certain manner(s) may be included (or excluded) whereas interactions of other manner(s) may be excluded (or included). In some cases where data on an interaction may or may not be included at least partly dependent on date and/or time of interaction, interactions occurring on certain dates/times of day may be included (or excluded) whereas interactions at other dates/times of day may be excluded (or included).

Depending on the embodiment, various types of data relating to an interaction may possibly be included in data structure 210. Inclusion of the date and/or time of day may in some embodiments be useful, for instance if the date(s) and/or time(s) of day of interaction(s) via non-email channel(s) 150 may possibly affect the determination of how to handle an email message from an associated email address, and/or for instance for synchronization purposes. Additionally or alternatively for instance if it is desired that recent interactions may cause predetermined handling to be applied, the date/time of day may allow earlier interactions to be ignored when determining how to handle an email message, and/or may allow earlier interactions to be deleted from data structure 210, for instance during a routine periodic cleanup of data structure 210. However in some other embodiments the date and/or time of day may be omitted from data structure 210, for instance if the date/time of day of a non-email interaction does not affect the determination of how an email message from an associated email address is handled, and for instance if synchronization does not take place or does not rely on the data.

In some embodiments, both an identifier of the party to a non-email interaction and associated email address(es) and/or sending domain(s) may be included in data structure 210 for an interaction but in some other embodiments, either the identifier of the party or the associated email address(es)//sending domain(s) may be omitted, for instance if one may be determined from the other.

In some embodiments, it may be useful to include an identifier of the party to a non-email interaction, associated email address(es) and/or sending domain(s) if a determination of how to handle an email message is at least partly based on whether or not the party is a member of a group of predetermined members. The disclosure does not limit the group of predetermined members which may be any appropriate group. For instance, the group of predetermined members may possibly include selected companies or organizations which are included in the group due to reputation thereof, or companies/organizations who paid or otherwise registered to join the group, individuals who are employees/members of these companies/organizations and/or objects affiliated with these companies or organizations. However in some other embodiments, there may not be a group of predetermined members which affects handling.

The description of channel of interaction (relating to manner of interaction) may in some embodiments be useful to be included, for instance if only either the party identifier or associated email address(es)/sending domain(s) is stored, and the channel of interaction may be necessary in order to determine one from the other, and/or for instance if the channel of interaction may affect a determination of how to handle an email message from an associated email address. However, in some other embodiments a description of the channel of interaction may be omitted from data structure 210.

A description of all operation(s) performed, or selected operation(s) performed, during an interaction (relating to manner of interaction) may in some embodiments be useful to be included, for instance if the type of operation(s) may affect a determination of how to handle an email message from an associated address, but in some other embodiments this description may be omitted from data structure 210.

A user identifier may in some embodiments be included in data structure 210 for an interaction but in some other embodiments may be omitted from data structure 210, for instance if each user is associated with a separate data structure 210, for instance if data structure 210 is stored in memory included in a user system of user 120, and/or for instance if entries of interactions for a given user (e.g. user 120) are otherwise distinguishable from entries of interactions for other users. The disclosure does not limit the user identifier but for the sake of further illustration to the reader, some examples are now provided. In some embodiments, the user identifier may be the user identifier for an interaction with the party (e.g. login username within a website). Additionally or alternatively, in some embodiments, the user identifier may be an email address or other identifier associated with the machine user. Additionally or alternatively, in some embodiments, e.g. where data structure 210 is stored in memory included in a system associated with mailbox provider, the user identifier may be an identifier of the user for mailbox provider 140 (e.g. username of Internet account with ISP, username/email address in webmail, etc).

In embodiments where predetermined handling may be applied to any email message for user 120 from any email address associated with any party with which user 120 had a non-email interaction, data structure 210 may at least include identifiers of parties with which user 120 had non-email interactions and/or email addresses/sending domains associated with the parties, and optionally an identifier of user 120 (e.g. if data structure 210 also relates to interactions involving other user(s) besides user 120). In these embodiments, such data may be sufficient to enable a determination to apply predetermined handling to any email message for user 120 from any email address associated with any of these parties (whose non-email interactions with user 120 are noted in data structure 210).

Depending on the embodiment, non-email interactions involving the same party and user 120 may be separately listed in data structure 210, or at least part of the non-email interactions may be merged or optimized. Merging and optimization are discussed in more detail further below.

Depending on the embodiment, there may be one or more memory module(s) 200 each including one or more data structure(s) 210 noting interactions involving user 120 (and optionally interactions involving other users). Module(s) of memory 200 may be included in user system(s) associated with user 120, may be included in system(s) associated with mail box provider(s) 140, and/or may be included elsewhere in a network. Consequently, depending on the embodiment there may be one or more data structures 210 noting at least interactions involving user 210. In embodiments where there are more than one data structure 210 noting at least interactions involving user 120, the various data structures 210 may include the same data for user 120, or at least one of the data structures 210 may include more, less and/or different data for user 120. For instance, the data included in different data structures 210 for user 120 may relate to the same interactions, may relate to different interactions, or part of the data may relate to the same interactions and part to different interactions. Additionally or alternatively, for instance, the data included in different data structures 210 relating to the same interaction involving user 120 may be the same, different, or partly the same and partly different. In embodiments where it may be possible to have different data regarding user 120 in different data structures 210, there may optionally be a way to synchronize between the data of various data structures if and when it is desirable to do so. Synchronization is discussed in more detail below.

FIG. 3 is a block diagram of a system 300 for enabling determination of handling of email messages, according to some embodiments of the presently disclosed subject matter. In the illustrated embodiments, system 300 includes one or more tracker module(s) 310 and optionally one or more memory module(s) 340. Depending on the embodiment any tracker module 310 may or may not include an associator module 350.

For simplicity of description, tracker 310, memory 340 and/or associator 350 are referred to below in the single form, but such reference should be construed to include embodiments with a single and/or a plural number of module(s), as appropriate for specific implementations. When included, each of tracker 310, memory 340 and/or associator 350 may be made up of any combination of hardware, software and/or firmware capable of performing the operations as defined and explained herein.

For instance, tracker 310 may be configured to store in memory (e.g. in memory 340 and/or memory external to system 300) at least data relating to non-email interactions which include user 120. Memory 340 may for instance be an example of memory 200 and may be configured to include at least one data structure 210. Associator module 350 may be configured, for instance, to associate a party to an interaction (e.g. by way of party identifier) with email address(es) and/or sending domain(s).

Depending on the embodiment, modules in system 300 may be concentrated in the same location, for instance in one unit or in various units in proximity of one another, or modules of system 300 may be dispersed over various locations.

In some embodiments, system 300 or a part thereof may be included in a user system associated with user 120. For instance, in some of these embodiments system 300, or part thereof, may comprise or be comprised in any of the following in a user system: a web browser; a mail client (e.g. email client application, etc); an instant messaging client; any other type of Internet client; a peer-to-peer application; a user interface; an SMS application; an MMS application; a messaging application; any other application; a plug-in, an add-on, a toolbar or an applet for a browser, mail client, instant messaging client or any other application; a standalone client; and/or any other element with a suitable configuration in a user system.

In embodiments where user 120 is associated with more than one user system, then, depending on the embodiment, a separate system 300 may or may not be included in each of these user systems. For instance, when separate systems 300 are included in different user systems, each system 300 may record interactions involving user 120 when using the corresponding user system. The recorded interactions may or may not be synchronized across some or all user systems. Synchronization is discussed in more detail below.

Additionally or alternatively, in some embodiments one or more system(s) 300 or a part thereof may be included elsewhere in a network, for example comprising or being comprised in one or more system(s) in a network. Examples of such a system in a network may include a website; a gateway; a proxy server; any other type of server; a web service, any other suitable element servicing multiple user systems; and/or an element with any other suitable configuration.

Alternatively to the example shown in FIG. 3, system 300 may in some examples include fewer, more and/or different modules than shown in FIG. 3. Alternatively to the example shown in FIG. 3, the functionality of system 300 may in some examples be divided differently among the modules illustrated in FIG. 3. Alternatively to the example shown in FIG. 3, the functionality of system 300 described herein may in some examples be divided into fewer, more and/or different modules than shown in FIG. 3 and/or system 300 may in some examples include additional, less, and/or different functionality than described herein.

FIG. 4 is a block diagram of a system 400 for handling email messages, according to some embodiments of the presently disclosed subject matter. In the illustrated embodiments, system 400 includes one or more checker module(s) 420, one or more handler module(s) 430 and optionally one or more memory module(s) 440. Depending on the embodiment any checker module 410 may or may not include an associator module 450.

For simplicity of description, checker 420, handler 430, memory 440 and/or associator 350 are referred to below in the single form, but such reference should be construed to include embodiments with a single and/or a plural number of module(s), as appropriate for specific implementations. When included, each of checker 420, handler 430, memory 440 and/or associator 450 may be made up of any combination of hardware, software and/or firmware capable of performing the operations as defined and explained herein.

Memory 440 may for instance be an example of memory 200 and may be configured to include at least one data structure 210. Checker 420 may be configured, for instance, at least to determine at least partly based on available data relating to at least one non-email interaction involving user 120 and at least one party, how to handle an email message for user 120 from an email address associated with the party/ies. Checker 420 may be configured to make the determination in any appropriate way. For example, checker 420 may be configured to search and/or cause to have searched one or more data structures 210 in memory (e.g. in memory 440 and/or external to system 400) for data on interactions. Handler 430 may, for instance, be configured to handle the email message according to the determination. Associator module 450 may be configured, for instance, to associate the email address or sending domain of the email message with one or more party/ies (e.g. by way of identifier(s) of party/ies, email address and/or sending domain, recorded for the non-email interaction(s)).

Depending on the embodiment, modules in system 400 may be concentrated in the same location, for instance in one unit or in various units in proximity of one another, or modules of system 400 may be dispersed over various locations.

In some embodiments, system 400 or a part thereof may be included in a user system associated with user 120. For instance, in some of these embodiments system 400, or part thereof may comprise or be comprised in any of the following in a user system: a web browser; a mail client (e.g. email client application, etc); an instant messaging client; any other type of Internet client; a peer-to-peer application; a user interface; an SMS application; an MMS application; a messaging application; any other application; a plug-in, an add-on, a toolbar or an applet for a browser, mail client, instant messaging client or any other application; a standalone client; and/or any other element with a suitable configuration in a user system.

In embodiments where user 120 is associated with more than one user system, then, depending on the embodiment, a separate system 400 may or may not be included in each of these user systems. For instance, when separate systems 300 are included in different user systems, each system 400 may handle email messages for user 120 when user 120 is using the corresponding user system.

Additionally or alternatively, one or more system(s) 400 or a part thereof may be included in system(s) associated with mailbox provider 140 and/or elsewhere in a network, for example comprising or being comprised in one or more provider system(s) and/or system(s) in a network. Examples of such a provider system or system in a network may include: a website; a gateway; a proxy server; any other type of server; a Web service, any other suitable element servicing multiple user systems; and/or an element with any other suitable configuration.

Alternatively to the example shown in FIG. 4, system 400 may in some examples include fewer, more and/or different modules than shown in FIG. 4. Alternatively to the example shown in FIG. 4, the functionality of system 400 may in some examples be divided differently among the modules illustrated in FIG. 4. Alternatively to the example shown in FIG. 4, the functionality of system 400 described herein may in some examples be divided into fewer, more and/or different modules than shown in FIG. 4 and/or system 400 may in some examples include additional, less, and/or different functionality than described herein.

In some embodiments, systems 300 and 400 may be consolidated together into a unified system. In these embodiments, the unified system may or may not include the same modules as in embodiments where the systems were separate. For instance, it is possible that some of the modules may be consolidated, such as memory 340 with memory 440 and/or associator 350 with associator 450.

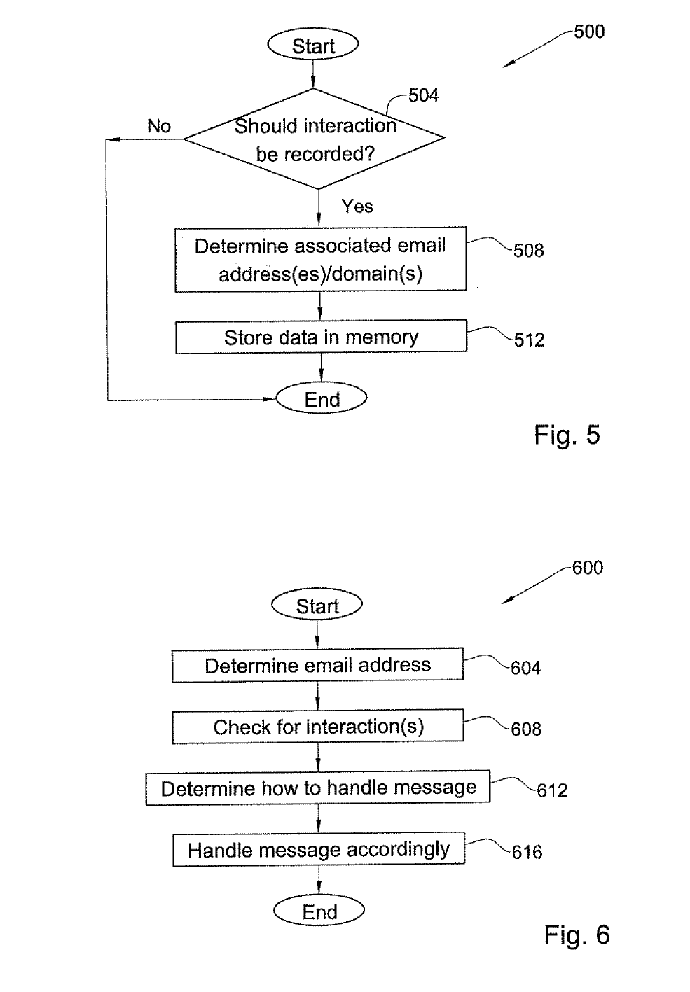

FIG. 5 is a flowchart of a method 500 of enabling determination of handling of email messages, according to some embodiments of the presently disclosed subject matter.

It is assumed that system 300 for instance tracker 310 has detected a non-email interaction of user 120 with a party (e.g. party 110a) via a network.

The disclosure does not limit the possible non-email interaction channels, and a non-email interaction may include any suitable channel. However for further illustration to the reader some examples are now provided.

Examples of a non-email interaction channel may include any of the following inter-alia: visiting a website, activating a non-mobile application, downloading a non-mobile application, other interacting with a non-mobile application, activating a mobile application, downloading a mobile application, other interacting with a mobile application, interacting with a social network account, interacting with a social network page, other interacting via a social network, or receiving a non-email message (e.g. SMS [“Short Message Service”], MMS [“Multi-media Messaging Service”], social network messages [e.g. Facebook messages, Twitter “tweets”, etc], instant messaging messages, etc).

In embodiments where the interaction is via a social network (e.g. interacting with a social network account, interacting with a social network page, receiving a social network message, other interacting via a social network, etc), the disclosure does not limit the social network and may include any appropriate social network, some of which are mentioned herein.

The disclosure does not limit the possible operations which may be performed by user 120 during the interaction and any suitable operation(s) may be performed. However for the sake of further illustration some examples are now provided.

For example, interaction where the channel of interaction includes visiting a website may include user 120 performing any of the following operations within the website: clicking button, checking checkbox, etc.

Additionally or alternatively for example, interaction where the channel of interaction includes activating, downloading or otherwise interacting with a mobile or non-mobile application may include user 120 performing any of the following operations with the application: clicking button, checking a checkbox, etc.

Additionally or alternatively for example, interaction where the channel of interaction includes interacting with an account on the Twitter social network may include user 120 performing any of the following operations: following the twitter account, re-tweeting a tweet made by the account, commenting on a tweet made by the account, etc.

Additionally or alternatively, for example, interaction where the channel of interaction includes interacting with an account or page of the social network Facebook may include user 120 performing any of the following operations: “liking” published content, “liking” a page, posting on a wall, commenting on a post on a wall, etc.

Additionally or alternatively, for example, interaction where the channel of interaction includes interacting with an account or page of the social network LinkedIn may include user 120 performing any appropriate operation(s).

Additionally or alternatively, for example, interaction where the channel of interaction includes receiving a non-email message (e.g. SMS, MMS, social network messages, instant, etc) may include user 120 performing any of the following operations: opening the message, reading the message, responding to the message, forwarding the message, commenting on the message, etc.

In the illustrated embodiments, in optional stage 504, system 300, for instance, tracker 310 determines whether or not the detected interaction should be recorded.

Depending on the embodiment, any detected non-email interaction involving user 120 may be recorded, or any detected non-email interaction involving user 120 may not necessarily be recorded.

For instance, the determination of whether or not to record the detected interaction may be at least partly dependent on the party to the interaction, and if the interaction involved a party which is not a member of a predetermined group (or alternatively is a member of a group) then the interaction may not be recorded. Additionally or alternatively, for instance, the determination of whether or not to record an interaction may be at least partly dependent on the date/time of day of interaction. Additionally or alternatively, for instance the determination of whether or not to record an interaction may be at least partly dependent on the manner of interaction (e.g. interaction channel, operation(s) performed during interaction, etc). Additionally or alternatively, the determination of whether or not to record an interaction may be at least partly dependent on earlier recorded interaction(s), and for instance data regarding the interaction may not be stored if the data would not cause any email message to be handled differently, than the email message would be handled based on the data already stored for previous interaction(s) (without consideration of the data on this interaction).

If it is determined not to record the interaction (no to stage 504), then in the illustrated embodiments, method 500 ends. Otherwise if it is determined to record the interaction (yes to stage 504), then in the illustrated embodiments, method 500 proceeds to stage 508.

In some embodiments, stage 504 may be omitted, for instance if all detected non-email interactions are recorded.

In the illustrated embodiments, in optional stage 508, system 300, for instance associator 350 associates email address(es) or sending domain(s) with the party with which user 120 interacted in the detected interaction (e.g. by way of party identifier).

The disclosure does not limit how the association is performed and the association may be performed using any appropriate technique. However for the sake of further illustration to the reader some examples of techniques are now presented.

For example, the association may be performed using data relating to the party to the interaction, e.g. the identifier of the party.

For instance, if the uniform resource locator URL (e.g. www.acme com, www.facebook.comlaccount-name, etc.) identifies the party (e.g. website, social network account such as Facebook or Twitter, etc) there may be an algorithm for associating URLs or part of the URLs to sending domains. Additionally or alternatively, for instance there may be a maintained data structure (e.g. data structure 210 or otherwise), for instance for parties which are predetermined members of a group, or for any parties, which denotes the association between the domain part of a URL (and/or any other part of a URL, or the entire URL) and a sending domain (e.g. domain part of URL “*.acme.com” may be denoted as associated with sending domain @mail.acme.com). Such a data structure, may possibly be available via a network and updated from time to time as needed. Additionally or alternatively, for instance if the party is a website or page, there may be a block within the website or page HTML that is similar to an HTML comment which lists possible association(s), e.g. to a sending domain.

Additionally or alternatively, if an identifier for a non-email message identifies the party which sent a non-email message, the same maintained data structure for URLs described above or a different data structure, may denote associations between sender party identifiers with respect to non-email messages and sending domains or email addresses, for instance for parties which are predetermined members of a group, or for any parties.

Optionally, user 120 may be prompted to accept or not accept the proposed association. If user 120 accepts the association, then method 500 may continue. Otherwise method 500 may end or stage 508 may be repeated until a proposed association is accepted by user 120.

In some embodiments, stage 508 may be omitted, for instance if email address(es) and domain(s) will not be stored for this interaction.

In the illustrated embodiments, in stage 512, system 300 for instance tracker 310 stores data relating to the detected interaction in memory (e.g. in data structure(s) 210 in memory 340 and/or in memory external to system 300).

The disclosure does not limit the type(s) of data relating to the interaction which may be stored in memory in stage 512, and any appropriate data may be stored. Some examples of data relating to an interaction which may be included in data structure 210 were discussed previously with reference to FIG. 2. Depending on the embodiment, any of these examples of data and/or other example(s) of data may be stored in memory for this interaction. Depending on the embodiment, the type(s) of data stored for various interactions may be the same or may vary depending for instance on the interaction, and/or on implementation.

The data that may be stored may or may not include data relating to the channel of interaction. For instance, data on the channel may be included if predetermined handling may be applied to an email message from an email address if non-email interaction(s) involving user 120 and party/ies associated with the email address included certain channel(s) (or excluded certain channel(s)), and/or data on the channel may be included if the type of predetermined handling to be applied to an email message from an email address may (at least partly) depend on the channel(s) of non-email interaction(s) involving user 120 and party/ies associated with the email address. Additionally or alternatively, data relating to the channel may be included, for instance to facilitate association between the party to an interaction and email address(es), e.g. by system 400.

Additionally or alternatively, the data that may be stored may or may not include data relating to operation(s) during the interaction. For instance, data on operation(s) may be included if predetermined handling may be applied to an email message from an email address if non-email interaction(s) involving user 120 and party/ies associated with the email address included certain operations(s) (or excluded certain operation(s)), and/or data on operation(s) may be included if the type of predetermined handling to be applied to an email message from an email address may (at least partly) depend on the operation(s) performed during non-email interaction(s) involving user 120 and party/ies associated with the email address. In embodiments where operation(s) is/are recorded, the operation(s) that may be recorded may include operation(s) which may affect the determination of how to handle an email message, or may include both operation(s) which may affect and operation(s) which may not affect the determination of how to handle an email message.

Additionally or alternatively, the data that may be stored may or may not include date and time of day. For instance, data on date and time of day may be included if predetermined handling may be applied to an email message from an email address if non-email interaction(s) involving user 120 and party/ies associated with the email address occurred at certain date(s)/time(s) of day (or did not occur at certain date(s)/time(s) of day), and/or data on date and time of day may be included if the type of predetermined handling to be applied to an email message from an email address may (at least partly) depend on the date(s)/time(s) of day of non-email interaction(s) involving user 120 and party/ies associated with the email address. Additionally or alternatively, the date and/or time of day may be included for instance, to facilitate synchronization.

Additionally or alternatively, the data that may be stored may or may not include an identifier of the party to the interaction, and/or if associated in stage 508, associated email address(es) and/or sending domain(s). For instance, when included, a party identifier, email address(es) and/or sending domain(s) may allow predetermined handling to be applied to an email message from an email address associated with any party which is (or is not) a member of a predetermined group of members, and/or may allow determination of type of predetermined handling to be applied to an email message to (at least partly) depend on whether or not associated party/ies is/are member(s). Additionally or alternatively, when included, a party identifier, email address(es) and/or sending domain(s) may allow predetermined handling to be applied to any email message which is from an email address associated with the party to the interaction.

The data that may be stored may or may not include a user identifier. For instance, the user identifier may be included to enable identification of the data as relating to the user.

Optionally, the data stored for the interaction (e.g. in data structure 210) may be optimized due to data already stored (e.g. already present in data structure 210), and/or data already stored (e.g. in data structure 210) may be optimized due to data on the current interaction. Optionally the data stored for the interaction may be merged with data from previous interactions. Optionally, the storing of data for the interaction in one data structure 210 may require synchronization of the data in one or more other data structures 210 which include data relating to user 120, assuming there is a plurality of such data structures. Optimization, merging and synchronization are discussed in more detail below.

Optionally, some or all email interactions involving user 120 may be detected and recorded, e.g. by system 300. For an email interaction, stage 508 may not be necessary. In embodiments where an email interaction may be recorded, the type(s) of data which may be stored for an email interaction may be the same, different, or partly the same and partly different than the type(s) of data stored for a non-email interaction.

In the illustrated embodiments, method 500 then ends.

Alternatively to the embodiments illustrated in FIG. 5, stages which are shown in FIG. 5 as being executed sequentially may in some other embodiments be executed in parallel. Alternatively to the embodiments illustrated in FIG. 5 method 500 may in some other embodiments include more, fewer and/or different stages than illustrated in FIG. 5. Alternatively to the embodiments illustrated in FIG. 5, stages may in some other embodiments be executed in a different order than illustrated in FIG. 5.

FIG. 6 is a flowchart of a method 600 of handling email messages, according to some embodiments of the presently disclosed subject matter.

In the illustrated embodiments, in stage 604, system 300, for instance checker 320 determines the email address from which an email message for user 120 was sent via a network. The email address from which the email message was sent may be determined in any conventional way.

In the illustrated embodiments, in stage 608, system 400, for instance checker 420 determines if there were non-email interaction(s) with party/ies associated with the email address of the email message.

The disclosure does not limit how the checking occurs but for the sake of further illustration to the reader, some examples will now be presented.

For instance, assuming that an entry in data structure 210 relating to an interaction with a party includes associated email address(es) (e.g. from stage 508), then system 400 may determine that the interaction was with an associated party if the email address of the email message matches one of the one or more of the included email address(es). Additionally or alternatively for instance assuming an entry for the interaction in data structure 210 includes associated sending domain(s), then system 400 may determine that the interaction was with an associated party if the sending domain of the email address of the email message matches one of the one or more included sending domain(s). Additionally or alternatively for instance, assuming the entry for an interaction does not include email addresse(s)/sending domain(s) but just a (different) identifier of the party, then associator 450 may determine associated email address(es) for the interaction and checker 420 may compare the determined associated email address(es) with the email address of the email message to see if there is a match (or associator 450 may determine associated sending domain(s) for the interaction and checker 420 may compare the determined associated domain(s) with the domain of the email address of the email message to see if there is a match).

In embodiments where associator 450 may determine associated email address(s)/sending domain(s), the disclosure does not limit how the association is performed and associator 450 may use any suitable technique, for instance, any of the techniques described above with reference to stage 508.

Depending on the embodiment, one or more data structure(s) 210 stored locally (e.g. in memory 440) and/or remotely to checker 420 (e.g. in memory external to system 400) may be checked for interactions.

Depending on the embodiment, system 400 may or may not check for email interactions, for instance email messages sent from the same email address and/or same sending domain as the current email message, when determining how to handle the current email message.

Depending on the embodiment, system 400 may or may not check if the email address of the current email message is associated with a sender on a list of white senders, which are considered to be senders of legitimate content.

Depending on the embodiment, system 400 may or may not check if the email address of the current email message is on an address list of user 120.

Depending on the embodiment, system 400 may or may not check if the email address of the current email message is of a sender in a social network of user 120 (e.g. via application programming interface for Google+ circles, etc).

In the illustrated embodiments, in stage 612, system 400, for instance checker 420 determines how to handle the email message.

In some embodiments if it was determined, e.g. in stage 608, that there was at least one non-email interaction(s) with party/ies associated with the email address of the email message, then the determination of how to handle the email message may, for instance, be at least partly based on available data relating to these interaction(s). Available data relating to these interaction(s) may include, for example, data stored in one or more data structure(s) 210 in memory, data determined by system 400 (e.g. by associator 450) and/or data otherwise available to system 400.

The disclosure does not limit how the determination of how to handle the email message may be at least partly based on available data relating to non-email interaction(s) involving user 120 and party/ies associated with the email address, and any appropriate basis may be applicable. However for the sake of further illustration to the reader, some examples are now presented.

For example, in some embodiments where the determination of how to handle is at least partly based on available data, as long as there is available data relating to any non-email interaction with a party associated with the email address of the email message, the non-email interaction may be considered to justify applying predetermined handling to the email message. For example, in some embodiments where the determination of how to handle is at least partly based on available data, only if the available data includes certain data values relating to the non-email interaction(s), the non-email interaction(s) may be considered to justify applying predetermined handling. For example, in some embodiments where the determination of how to handle is at least partly based on available data, the type of predetermined handling to be applied may vary depending on the available data on non-email interaction(s).

For example, in some embodiments where the determination of how to handle an email message may at least partly depend on available data relating to non-email interaction(s) involving user 120 and party/ies associated with the email address, the available data on which the determination may at least partly depend may include any appropriate data such as the date/time of day of the interaction, manner of interaction (e.g. channel, operation(s)), identity of party (e.g. whether or not the party is a predetermined member of a group), etc. In some of these embodiments, for instance, whether or not the interaction(s) may be considered to justify predetermined handling, and/or the type of predetermined handling, may depend on available data such as the date/time of day of the interaction, manner of interaction (e.g. channel, operation(s)), identity of party (e.g. whether or not the party is a predetermined member of a group), etc. For instance, predetermined handling may be considered justified in some cases if non-email interaction(s) involving user 120 and party/ies associated with the email address occurred at certain date(s)/time(s) of day (or did not occur at certain date(s)/time(s) of day), and/or the type of predetermined handling may (at least partly) depend on the date(s)/time(s) of day of non-email interaction(s) involving user 120 and party/ies associated with the email address. Additionally or alternatively for instance, predetermined handling may be considered justified in some cases if non-email interaction(s) involving user 120 and party/ies associated with the email address included certain channel(s) (or excluded certain channel(s)), and/or the type of predetermined handling may (at least partly) depend on the channel(s) of non-email interaction(s) involving user 120 and party/ies associated with the email address. Additionally or alternatively, for instance, predetermined handling may be considered justified in some cases if non-email interaction(s) involving user 120 and party/ies associated with the email address included certain operations(s) (or excluded certain operation(s)), and/or the type of predetermined handling to be applied to an email message from an email address may (at least partly) depend on the operation(s) performed during non-email interaction(s) involving user 120 and party/ies associated with the email address. Additionally or alternatively for instance, predetermined handling may be considered justified in some cases if any of the associated party/ies is (or is not) a member of a predetermined group of members, and/or the type of predetermined handling may (at least partly) depend on whether or not associated party/ies is/are member(s).

For example, it is possible in some embodiments, that when an earlier email message from the same email address was received, the non-email interaction(s) with associated party/ies for which there was available data at that time justified a certain type of predetermined handling, but since then additional non-email interaction(s) took place with the associated party/ies, and therefore it may be determined at least partly based on the currently available data that there should be additional, less and/or different handling of the current email message compared to the handling applied to the earlier email message. Alternatively, for example, it is possible in some embodiments that when an earlier email message from the same email address was received, there were no available data on non-email interaction(s) with associated party/ies and therefore the email message was handled a certain way but since then non-email interaction(s) took place with associated party/ies and therefore it may be determined at least partly based on the currently available data to handle the current email message differently compared to the handling applied to the earlier email message. Additionally or alternatively, for example, in any of these embodiments, the fact that there was an earlier email message from the same email address may or may not affect the handling of the current email message (in conjunction with, or to the exclusion of, consideration of non-email interaction(s)). For instance, if to the exclusion of non-email interaction(s), data relating to non-email interaction(s) may be deleted or ignored.

Depending on the embodiment, checker 420 may or may not take into account any other appropriate factor(s) (besides non-email interaction(s)) in determining how to handle the email message in stage 612. Such factor(s) are not limited by the disclosure. Examples of such factor may include any of the following, inter-alia: any earlier email message received from the same email address, any earlier email message received from the same sending domain, whether or not the email address is associated with a sender on a list of white senders, whether or not the email address is associated with a sender in a social network of user 120, whether or not the email address is on the address list of user 120 and/or the identity of user 120.

In the illustrated embodiments in stage 616, system 400, for instance handler 430 handles the email message in accordance with the determination in stage 612 of how to handle the email message.

In some embodiments, the email message may be handled conventionally or predetermined handling may be applied. For instance, predetermined handling may be applied at least partly based on available data on non-email interaction(s) with associated party/ies, at least partly because of an earlier email message for user 120 from the same email address, at least partly because of an earlier email message for user 120 from the same sending domain, at least partly because the email address is on an address list of user 120, at least partly because the sender of the email message is on a white list, at least partly because the email address is associated with a sender in a social network of user 120, at least partly based on the identity of user 120 (e.g. user 120 has not previously vetoed predetermined handling), and/or at least partly based on any other reason.

Depending on the embodiment where predetermined handling is applied, the (type of) predetermined handling may or may not be the same for the current email message as for any other email message where predetermined handling is applied. For instance the type of predetermined handling may differ due to different non-email interactions and/or due to any other reason, as discussed above.

The disclosure does not limit the predetermined handling applied in stage 616 and the predetermined handling may include any appropriate handling. However for the sake of further illustration to the reader, some examples are now presented.

For example, predetermined handling may or may not include authorizing one or more elements in the email message. The disclosure does not limit the element(s) which may be authorized and the authorized element(s) may include any appropriate element(s). Examples of element(s) which may be authorized include image(s), graphic element(s), complex font(s), interactive features, HTML element(s) (e.g. HTML form(s), HTML object(s), etc.), embedded object elements (e.g. Adobe Flash, Microsoft Silverlight, etc), script(s) (such as Javascript, etc.), message attachment(s), marker(s), and/or any other element(s). As noted above, in conventional handling one or more of these element(s) may be filtered, for instance if the email message is from an email address that is not known to have been the source of any earlier email message for user 120, is not known to be associated with a sender of legitimate content, and/or is not on the address list of user 120. For instance, under conventional handling, images that are filtered may only be provided to the user once the user has manually selected to view the images (e.g. by clicking “download images” button, by clicking “show images” button, etc.).

In embodiments where different types of predetermined handling may be applied, one or more of the types of element(s) authorized for a given type of predetermined handling may optionally be different than for another type of predetermined handling.

To provide a more detailed example of possible differences in the user experience between conventional handling and possible predetermined handling with regard to one or more images in an email message, assume that an email message is received from sender@mail.acme.com which includes one or more images. Under conventional handling, the user would view the message without the images, and would then click a “show images” button or equivalent. The user would then view the message including the images. In contrast, for an example of possible predetermined handling, assume that the user browsed a website of Acme Corporation at www.acme.com. The interaction involving Acme Corporation (or equivalently the website) and the user was recorded. The user may afterward receive an email message from sender@mail.acme.com with images. The record of the earlier interaction may be found, and therefore due to the application of predetermined handling which authorizes the images, the user may view the message with images. Additionally or alternatively for an example of possible predetermined handling, assume that the user performed a “like” operation in his Facebook account for the page of Acme Corporation. The interaction involving Acme Corporation (or equivalently the page) and the user was recorded. The user may afterward receive an email message from sender@mail.acme.com with images. The record of the earlier interaction may be found, and therefore due to the application of predetermined handling which authorizes the images, the user may view the message with images.

In another more detailed example of possible differences in the user experience between conventional handling and possible predetermined handling with regard to fetching of additional message data in an email message, assume that an email message is received from sender@mail.acme.com which includes markers. Under conventional handling, assume that a pointer (to the additional message data) which is enclosed by the markers would not be activated without user authorization. In contrast, for an example of possible predetermined handling, assume that the user browsed a website of Acme Corporation at www.acme.com. The interaction involving Acme Corporation (or equivalently the website) and the user was recorded. The user may afterward receive an email message from sender@mail.acme.com with the markers. The record of the earlier interaction may be found, and therefore due to the application of predetermined handling which activates the pointer without prompting the user for authorization. Additionally or alternatively for an example of possible predetermined handling, assume that the user performed a “like” operation in his Facebook account for the page of Acme Corporation. The interaction involving Acme Corporation (or equivalently the page) and the user was recorded. The user may afterward receive an email message from sender@mail.acme.com with the markers. The record of the earlier interaction may be found, and therefore, due to the application of predetermined handling, the pointer may be activated without prompting the user for authorization.

Additionally or alternatively, for example, predetermined handling may or may not include different classification of the email message than under conventional handling. For instance, in some embodiments under conventional handling an email message may be more likely to be classified as spam whereas under predetermined handling an email message may be more likely to not be classified as spam. Additionally or alternatively for classification, in some embodiments for instance under predetermined handling an email message may be more likely to be classified as important or classified as flagged for importance than if conventional handling had been applied.

Additionally or alternatively, for example, predetermined handling may or may not include placement of the email message in a predetermined folder. The predetermined folder may, for instance, be different than the folder in which the email message would have been placed under conventional handling.

Additionally or alternatively, for example, predetermined handling may or may not include enabling the email message to be displayed differently than would have been the case under conventional handling. The display under predetermined handling may differ in any appropriate way, for instance there may be a visual indication (e.g. styling, font, color, etc), an image associated with the email address (e.g. associated with an individual sender of the email message, associated with the company, organization or other group to which the email address belongs, etc), etc.

Additionally or alternatively, for example, predetermined handling may or may not include enhancing the email message, for instance by adding one or more elements. The disclosure does not limit the element(s) that may be added, and the added element(s) may include any appropriate element(s). Examples of element(s) which may be added may include image(s), graphic element(s), scripts, complex font(s), interactive feature(s), HTML element(s), embedded object element(s), attachment(s), and/or any other element(s), etc.

In embodiments where different types of predetermined handling may be applied, one or more of the types of element(s) added for a given type of predetermined handling may optionally be different than for another type of predetermined handling.

Additionally or alternatively, for example, predetermined handling may or may not include removing one or more elements in order to enhance the message. The disclosure does not limit the element(s) that may be removed, and the removed element(s) may include any appropriate element(s). Examples of element(s) which may be removed may include image(s), graphic element(s), scripts, complex font(s), interactive feature(s), HTML element(s), embedded object element(s), attachment(s), and/or any other element(s), etc.

In embodiments where different types of predetermined handling may be applied, one or more of the types of element(s) removed for a given type of predetermined handling may optionally be different than for another type of predetermined handling.

During method 600 or as a result of method 600 stored data (e.g. in data structure 210) may or may not be optimized, merged or synchronized. Optimization, merging and synchronization are discussed in more detail below.

Depending on the embodiment, system 400 (e.g. checker 420) may or may not inform system 300 (e.g. 310) that it is no longer necessary to record non-email interactions relating to the party/ies associated with the email address, or to only record non-email interactions relating to the associated party/ies which would require a change in the predetermined handling to be applied to subsequent email messages.

In the illustrated embodiments, method 600 then ends.

Alternatively to the embodiments illustrated in FIG. 6, stages which are shown in FIG. 6 as being executed sequentially may in some other embodiments be executed in parallel. Alternatively to the embodiments illustrated in FIG. 6 method 600 may in some other embodiments include more, fewer and/or different stages than illustrated in FIG. 6. Alternatively to the embodiments illustrated in FIG. 6, stages may in some other embodiments be executed in a different order than illustrated in FIG. 6.

As mentioned above, in some embodiments, optimization, merging, and/or synchronization of data may optionally occur. The disclosure does not limit how or when any of these activities may occur, the reason for any of these activities, the data subject to any of these activities, or the result of any of these activities. Any of these activities may occur at any appropriate time, in any appropriate way, for any appropriate reason, relating to any appropriate data, and with any appropriate result. However for the sake of further illustration to the reader some examples are now provided. For example, in some embodiments, merging, optimization and/or synchronization may occur periodically, and/or as a result of an event. The event may be any appropriate event. Possibly, an appropriate event may include the occurrence of a new interaction that is to be noted in data structure 210, the provision of an email message for a user (e.g. user 120) whose email address is associated with a party with whom there was a non-email interaction with the user, a user system (e.g. of user 120) communicating with a system of provider 140, etc.

Additionally or alternatively, in some embodiments, data may optionally be optimized because data relating to one or more non-email interaction(s) may no longer be relevant, e.g. for determining how to handle an email message. For instance, assume there was/were earlier interaction(s) which justified allowing certain operation(s) on any email message from an associated email address, but a later interaction justifies allowing the same operation(s) plus additional operation(s). In this instance, therefore an entry for the current interaction may optionally overwrite the entry/es for the earlier interaction(s), but in other instances overwriting may not occur. Additionally or alternatively, assume for instance, that once there is an email message from an email address associated with a party with whom user 120 had non-email interaction(s), data relating to one or more non-email interaction(s) may no longer be relevant in handling subsequent email messages. Instead, subsequent email messages may be handled in a certain way, regardless of the non-email interaction(s). The date in any entry/ies relating to the non-email interaction(s) may in this instance be optionally deleted because the fact that there was an email interaction determines the handling of the subsequent email messages (to the exclusion of consideration of non-email interaction(s)). However in other instances the data relating to the non-email interaction(s) may not be deleted either because it is still relevant, because the data will instead be ignored when handling subsequent email messages, or for any other reason.

Additionally or alternatively, in some embodiments optimization may optionally include, deletion of similar or identical data relating to similar interactions, but in other embodiments similar or identical data may not be deleted.

Additionally or alternatively in some embodiments, data may optionally be merged into fewer entry/ies in a data structure (e.g. data structure 210) than the number of corresponding interaction(s), but in other embodiments data may not be merged. Continuing with describing the former embodiments, in some cases data relating to all interactions involving a user and party/ies associated with the same email address may be merged (e.g. once there is a plurality of records for interactions of party/ies associated with the same email address, after there was an email message for the user from that email address, etc), so that only one entry remains relating to the same email address. Possibly, this entry may simply list the email address as one whose email message(s) require predetermined handling, and/or the type of predetermined handling which should take place due to past interactions. In other cases this type of merging may not occur or may occur at a different time, and/or other type(s) of merging may occur.

Additionally or alternatively, in some embodiments, data synchronization may optionally occur among data structures, if there is a plurality of data structures. For example, if there is more than one system 300 in various user system(s) of a user (e.g. user 120) and/or in a network, each of which when being used by the user records interactions in a separate data structure 210, then synchronization of data may optionally occur so that system 400 may have access to all recorded interactions. After synchronization in this example, the data regarding the user may be synchronized in all data structures with records regarding the user or not necessarily in all data structure(s) with records regarding the user. For instance, in this example there may possibly be a synchronized master data structure which system 400 may check. In other examples, synchronization may not occur and/or other type(s) of synchronization may occur.

Although embodiments described handling an email message at least partly based on non-email interaction(s), it will be understood that in some embodiments, similar methods and systems to those described above may be applied for handling any type of interaction at least partly based on other type(s) of interaction(s), mutatis mutandis. For instance, a non-email interaction involving a user may be handled at least partly based on data relating to other type(s) of interaction(s) (email and/or non-email) which involved the user. The type of currently handled interaction and other type(s) of interaction(s) are not limited by the disclosure and may include any appropriate types of interactions. However for the sake of farther illustration to the reader some examples are now presented. Assume, for example that data relating to interaction(s) with a website of a company or organization and/or relating to interaction(s) with a social network account or page of the company/organization is stored. Determination of how to handle another type of interaction may be at least partly based on this data, for instance how to handle an interaction with a mobile or non-mobile application of the company/organization (e.g. vis-a-vis downloading, activating, etc.). In another example, assume that data relating to received email message(s) is stored. Determination of how to handle another type of interaction may be at least partly based on this data, for instance how to handle a non-email message.

It will also be understood that in some embodiments a system or part of a system according to the presently disclosed subject matter may be a suitably programmed computer. Likewise, some embodiments of the presently disclosed subject matter contemplate a computer program being readable by a computer for executing a method of the presently disclosed subject matter. Some embodiments of the presently disclosed subject matter further contemplate a computer-readable memory tangibly embodying a program of instructions executable by the computer for executing a method of the presently disclosed subject matter.

While the presently disclosed subject matter has been shown and described with respect to particular embodiments, it is not thus limited. Numerous modifications, changes and improvements within the scope of the presently disclosed subject matter will now occur to the reader.

1. A method of enabling determination of handling of email messages, comprising:
storing in memory data relating to non-email interactions, via a network, involving a user and one or more parties;
thereby enabling determination of handling of email messages for said user, at least partly based on said data.

2. The method of claim 1, wherein said data includes data relating to manners of interaction, and wherein said thereby enabling includes: thereby enabling determination of handling at least partly based on said manners of interaction.

3. The method of claim 2, wherein said manners of interactions include channels of interaction.

4. The method of claim 2, wherein said manners of interaction include operations performed during interactions.

5. The method of claim 1, wherein said data includes at least one selected from a group comprising: dates or times of day of interaction, and wherein said thereby enabling includes: thereby enabling determination of handling at least partly based on said dates or times of day of interaction.

6. The method of claim 1, wherein said data includes at least one selected from a group comprising identifiers of parties, associated email addresses or associated sending domains, and wherein said thereby enabling includes: thereby enabling determination of handling at least partly based on whether or not parties are members of a group of predetermined members.

7. The method of claim 1, further comprising: associating parties with email addresses or sending domains, and wherein said data includes at least one selected from a group comprising: said email addresses or said sending domains.

8. The method of claim 1, wherein said data includes identifiers of said parties.

9. The method of claim 1, wherein said non-email interactions include at least one selected from a group comprising: visiting a website, activating a mobile application, downloading a mobile application, other interacting with a mobile application, activating a non-mobile application, downloading a non-mobile application, other interacting with a non-mobile application, interacting with a social network account, interacting with a social network page, other interacting via a social network, or receiving a non-email message.

10. The method of claim 1, wherein said thereby enabling includes: thereby enabling determination to apply predetermined handling to an email message from an email address associated with any of said parties.

11. The method of claim 1, further comprising: determining not to store in memory data relating to at least one non-email interaction involving said user, based on at least one selected from a group comprising: date of interaction, time of day of interaction, party identifier, manner of interaction, or data relating to at least one previous non-email interaction already in memory.

12. A method of handling email messages, comprising:
determining, at least partly based on available data relating to at least one non-email interaction involving a user and at least one party, how to handle an email message for said user sent via a network from an email address associated with said at least one party; and
handling said email message in accordance with said determining.

13. The method of claim 12, wherein said determining includes:
determining to apply predetermined handling to said email message because said available data relates to at least one non-email interaction involving said user and said at least one party.

14. The method of claim 12, wherein said determining includes:
determining how to handle said email message at least partly based on whether or not any of said at least one party is a member of a predetermined group of members.

15. The method of claim 12, wherein said data includes manner of interaction and wherein said determining includes:
determining how to handle said email message at least partly based on said manner.

16. The method of claim 12, wherein said data includes at least one of date or time of day of interaction and wherein said determining includes:
determining how to handle said email message at least partly based on said date or time of day.

17. The method of claim 12, wherein said handling includes: authorizing at least one element in said email message.

18. The method of claim 12, wherein said handling includes: adding at least one element to said email message.

19. The method of claim 12, wherein said handling includes at least one selected from a group comprising: classifying said email message differently than if predetermined handling was not applied, placing said email message in a predetermined folder; enabling email message to be displayed differently than if predetermined handling was not applied.

20. The method of claim 12, further comprising associating said email address with said at least one party.

21. The method of claim 12, further comprising: determining that said email address includes a sending domain which matches a sending domain associated with said at least one party, or that said email address matches an email address associated with said at least one party.

22. A system for enabling determination of handling of email messages, comprising:
a tracker capable of storing in memory data relating to non-email interactions via a network involving a user and one or more parties;
thereby enabling determination of handling of email messages for said user, at least partly based on said data.

23. The system of claim 22, wherein said system is comprised in at least one selected from a group including: a user system of said user or said network.

24. A system for handling email messages, comprising:
a checker capable of determining, at least partly based on available data relating to at least one non-email interaction involving a user and at least one party, how to handle an email message for said user sent via a network from an email address associated with said at least one party; and
a handler capable of handing said email message in accordance with said determining.

25. The system of claim 24, wherein said system is comprised in at least one selected from a group including: a user system of said user, said network, or a system associated with a mailbox provider.

26. The system of claim 24, further comprising: memory including at least part of said available data.

27. The system of claim 26, wherein at least part of said memory is located in a same location as said checker, or at least part of said memory is located in a remote location from said checker.

28. A computer program product comprising a non-transitory computer useable medium having computer readable program code embodied therein for enabling determination of handling of email messages, the computer program product comprising:
computer readable program code for causing the computer to store in memory data relating to non-email interactions, via a network, involving a user and one or more parties;
thereby enabling determination of handling of email messages for said user, at least partly based on said data.

29. A computer program product comprising a non-transitory computer useable medium having computer readable program code embodied therein for handling email messages, the computer program product comprising:
computer readable program code for causing the computer to determine, at least partly based on available data relating to at least one non-email interaction involving a user and at least one party, how to handle an email message for said user sent via a network from an email address associated with said at least one party; and
computer readable program code for causing the computer to handle said email message in accordance with said determining.
